(19) United States
(12) Patent Application Publication
(10) Pub. No.: US 2005/0022770 A1
(43) Pub. Date: Feb. 3, 2005

(54) Internal combustion engine starting apparatus

(76) Inventors: Shigeru Yumiyama, Hitachinaka (JP); Toshiyuki Innami, Mito (JP)

Correspondence Address: CROWELL & MORING LLP;INTELLECTUAL PROPERTY GROUP, P.O. BOX 14300, WASHINGTON, DC, 20044-4300, US

(21) Appl. No.: 10/771,142

(22) Filed: Feb. 4, 2004

(30) Foreign Application Priority Data
Feb. 6, 2003 (JP) 2003-029029

(51) Int. Cl. F02N 11/00

(52) U.S. Cl. 123/179.4; 123/179.25; 74/7 C

(57) ABSTRACT

Between the first pulley 22 fitted on the output shaft of the direct current motor 20 for driving the internal combustion engine 100 and the second pulley 11 fitted on the crankshaft of the internal combustion engine, the belt 40, which is power transmission means to transmit the driving power of the direct current motor to the crankshaft of the internal combustion engine, is installed. Between the output shaft 21 of the direct current motor and the first pulley 22, the lift off type one-way cam clutch 23, wherein the cam lifts off by the centrifugal force causing release of the power transmission engagement between the inner element and the outer element, is provided.

The present invention relates to an internal combustion engine starting apparatus installed on a vehicle that runs relying on the internal combustion engine. The invention concerns particularly to an internal combustion engine starting apparatus suitable especially for an idle stop system that performs the temporary-stopping and re-starting of the internal combustion engine at an intersection.

As a recent trend, a vehicle that has an idle stop system is becoming being in practical use. The system stops the internal combustion engine on the vehicle when the vehicle makes a halt at an intersection and re-starts the internal combustion engine on the vehicle's re-starting. At present however, the vehicle that has the idle stop system is limited to such vehicle like a hybrid car that uses therein a combination of an internal combustion engine and a motor. The motor used in the hybrid car is generally an alternating current motor driven by a 42-volt power. When use of an idle stop system is intended for a vehicle that is driven only by an internal combustion engine, use of a 42-volt alternating current motor is the most probable idea. This idea however has not been realized due to unacceptable strain on vehicle cost increase.

When, however, a plan that applies an idle stop system to a vehicle driven only by an internal combustion engine is intended, following ideas may be practicable based on the use of a motor driven by a 12-volt direct current as a starting apparatus for the internal combustion engine: 1) A use of a starter motor in a conventional configuration, and 2) A use of another start-up motor aside from the starter motor. In the first idea, which uses a starter motor, the internal combustion engine is started by the starter motor that has a pinion thereon, wherein the pinion engages, only at the time of starting, with a ring gear fitted on the crankshaft of the internal combustion engine. In the second idea, which uses another start-up motor, an arrangement is known, wherein, as the Laid-Open Japanese Patent Specification 2001-65441 for example shows, the start-up motor and the crankshaft of the internal combustion engine are linked full-time by a belt or a chain through a one-way clutch like a roller clutch and the internal combustion engine is started by making the clutch on only at the time of starting.

### SUMMARY OF THE INVENTION

However; 1) The art, wherein the internal combustion engine is re-started relying on the starter motor, brings a noise problem resulted from gear mesh sound that is emitted when the ring gear fitted on the crankshaft of the internal combustion engine engages with the pinion on the starter motor. The starter motor is used in the ordinary initial starting of an internal combustion engine. A probable gear mesh sound that will be emitted at such starting, however, would be not very intolerable to a driver because the driver is prepared to sense such noisy sound since the starting of the internal combustion engine by turning the ignition switch is the driver's intention. In an idle stop system however, the meshing sound emitted at the time of re-starting is sensed by the driver as noise. This is because of that, after making an engine stop due to halt on a red signal at an intersection, the internal combustion engine is re-started by, for example, an action for acceleration pedaling and this re-starting is hardly to be defined as a driver-initiated re-starting. Moreover, the gear meshing sound tends to be taken as intolerable noise appearing as a problem in the employing of an idle stop system since the frequency of re-starting in the idle stop system is considerably high.

2) The art, wherein another start-up motor is used, brings a life problem in that the length of service life of the apparatus in terms of frequency of use meets with problems such as breakage of a clutch, reduction of life of clutch mechanism, and reduction of life of the brush in a motor. These problems arise from a high-speed dragged-revolution of such clutch and motor, which are linked full-time to the internal combustion engine by a belt, caused by the internal combustion engine rotation that takes place once the engine starts. Between the motor and the internal combustion engine, a one-way clutch, which transmits the driving power from the motor in one direction, is installed. A roller clutch, used as a one-way clutch, allows transmission of reversing torque comes from the internal combustion engine adversely to the motor because of its mechanism. This adverse transmission brings a problem in that the clutch and the motor make dragged-revolution connecting to lowered life of the apparatus.

The purpose of the present invention is to provide an internal combustion starting apparatus that emits no noise and gives lesser affection to length of service life in terms of frequency of use of the apparatus.

(1) To attain above-mentioned purpose, the present invention provides an internal combustion engine starting apparatus with a motor that drives said internal combustion engine; power transmission means that transmits driving power of said motor to the crankshaft of said internal combustion engine, said means being arranged between a first pulley fitted on the output shaft of said motor and a second pulley fitted on the crankshaft of said internal combustion engine; and a lift off type one-way cam clutch arranged between said motor and said internal combustion engine, wherein a cam is lifted off by the centrifugal force causing release of power transmission engagement between an inner element and an outer element.

By this arrangement, gear mesh noise that the meshing of the pinion with the ring gear emits is eliminated, and lesser affection is given to the len gth of service life in terms of frequency of use of the apparatus even the internal combustion engine rotates at a high speed after being started thanks to the lifting off of the cam of the one-way clutch that takes place at a pre-set number of revolution.

(2) In the configuration mentioned in (1) above, it is preferred that said power transmission means is means for power-reducing transmission that reductively transmits power from said first pulley to said second pulley, and that said lift off type one-way cam clutch is arranged between the output shaft of said motor and said first pulley.

(3) In the configuration mentioned in (2) above, said motor is provided with a reducer therein, and said inner element of said lift off type one-way cam clutch is integrally arranged on the output shaft of said reducer, and said outer element is integrally arranged on said second pulley.

4) In the configuration mentioned in (1) above, it is preferred that said lift off type one-way cam clutch is set so that said cam lifts off when the number of revolution thereof falls between such speeds that one number of revolution at which said inner combustion engine can self-perform complete explosion and the other number of revolution at which said internal combustion engine can run idle maintaining self-revolution.

(5) In the configuration mentioned in (1) above, it is preferred that said configuration is comprised of a control means that increases a load on said internal combustion engine while the cam of said lift off type one-way cam clutch is being lifted off.

(6) In the configuration mentioned in (1) above, said configuration is further comprised of a relay that conveys electrical power supplied from a battery to said motor, a relay driving circuit that drives said relay, and an engine control unit that controls the internal combustion engine, wherein, at the time of initial starting-up, said relay is activated through operating an ignition switch to cause said motor to be driven, and, at the time of re-starting after idle stop, said engine control unit sends a command to said relay driving circuit so that said relay is activated to cause said motor to be driven.

(7) In the configuration mentioned in (1) above, it is preferred that said configuration is comprised of a starter motor that drives the crankshaft through engagement with the ring gear fitted on the crankshaft of said internal combustion engine, a relay that feeds electrical power supplied from a battery to said motor, a relay driving circuit that drives said relay, and an engine control unit that controls the internal combustion engine, wherein, at the time of initial starting-up, said starter motor is driven through operating an ignition switch, and, at the time of re-starting after idle stop, said engine control unit sends a command to said relay driving circuit so that said relay is activated to cause said motor to be driven.

(8) To attain above-mentioned purpose, the present invention provides an internal combustion engine starting apparatus that starts an internal combustion engine with a motor that drives said internal combustion engine and power transmission means that transmits driving power of said motor to the crankshaft of said internal combustion engine, wherein said power transmission means shuts off transmission of power from said internal combustion engine to said motor when the number of revolution of the crankshaft of said internal combustion engine rises beyond specified number of revolution.

By this arrangement, gear mesh noise that the meshing of a pinion with a ring gear emits is eliminated, and lesser affection is given to the length of service life in terms of frequency of use of the apparatus even the internal combustion engine rotates at a high speed after being started thanks to the shutting off of the transmission of power from the internal combustion engine conveyed by the power transmission means.

(9) To attain above-mentioned purpose, the present invention provides an internal combustion engine starting apparatus that starts an internal combustion engine with a motor that drives said internal combustion engine, and power transmission means that transmits driving power of said motor to the crankshaft of said internal combustion engine, said means being arranged between a first pulley fitted on the output shaft of said motor and a second pulley fitted on the crankshaft of said internal combustion engine; a lift off type one-way cam clutch arranged between said motor and said internal combustion engine, wherein a cam is lifted off by the centrifugal force causing release of power transmission engagement between an inner element and an outer element; and a control means that increases a load on said internal combustion engine while the cam of said lift off type one-way cam clutch is being lifted off.

By this arrangement, gear mesh noise that the meshing of a pinion with a ring gear emits is eliminated, and lesser affection is given to the length of service life in terms of frequency of use of the apparatus even said internal combustion engine rotates at a high speed after being started preventing a revving-up at the time of lift off of the cam thanks to the shutting off of the transmission of power from the internal combustion engine conveyed by the power transmission means.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is an illustration of an entire configuration of the internal combustion engine starting apparatus in one mode of embodiment of the present invention.

FIG. 2 is a side elevation of the apparatus shown in FIG. 1.

FIG. 3 is a fragmentary cross-sectional view to show construction of the lift off type one-way clutch to be used in the internal combustion engine starting apparatus in one mode of embodiment of the present invention.

FIG. 4 is a flow chart that shows the operation of the internal combustion engine starting apparatus in one mode of embodiment of the present invention.

FIG. 5 is an illustration that explains the operation of the lift off type one-way clutch to be used in the internal combustion engine starting apparatus in one mode of embodiment of the present invention.

FIG. 6 is an illustration of the entire configuration of the internal combustion engine starting apparatus in another mode of embodiment of the present invention.

FIG. 7 is a side elevation view of the apparatus in FIG. 6.

### DETAILED DESCRIPTION OF THE PREFERRED EMBODIMENTS

The present invention will be discussed hereinafter in detail in terms of the preferred embodiment according to the present invention with reference to the accompanying drawings. In the following description, numerous specific details are set forth in order to provide a thorough understan ding of the present invention. It will be obvious, however, to those skilled in the art that the present invention may be practiced without these specific details. In other instance, well-known structures are not shown in detail in order to avoid unnecessary obscurity of the present invention.

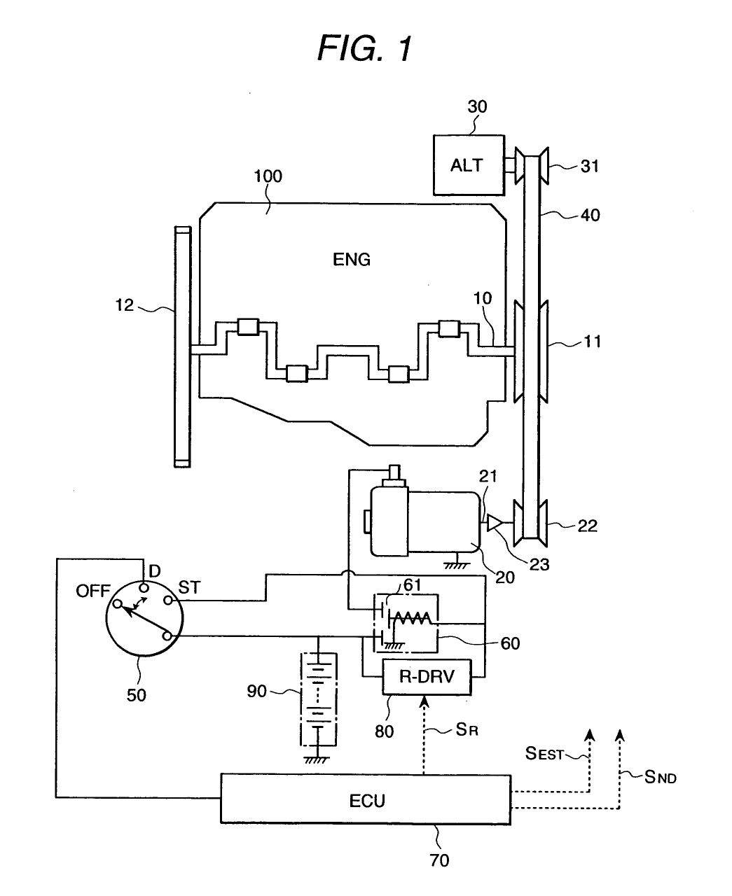

The following explains, using FIG. 1 to FIG. 5, the configuration and the operation of an internal combustion engine starting apparatus as one mode of embodiment of the present invention. This mode of embodiment is suitable for a vehicle that uses a small gasoline engine having an engine displacement of 2000 cc or less for example.

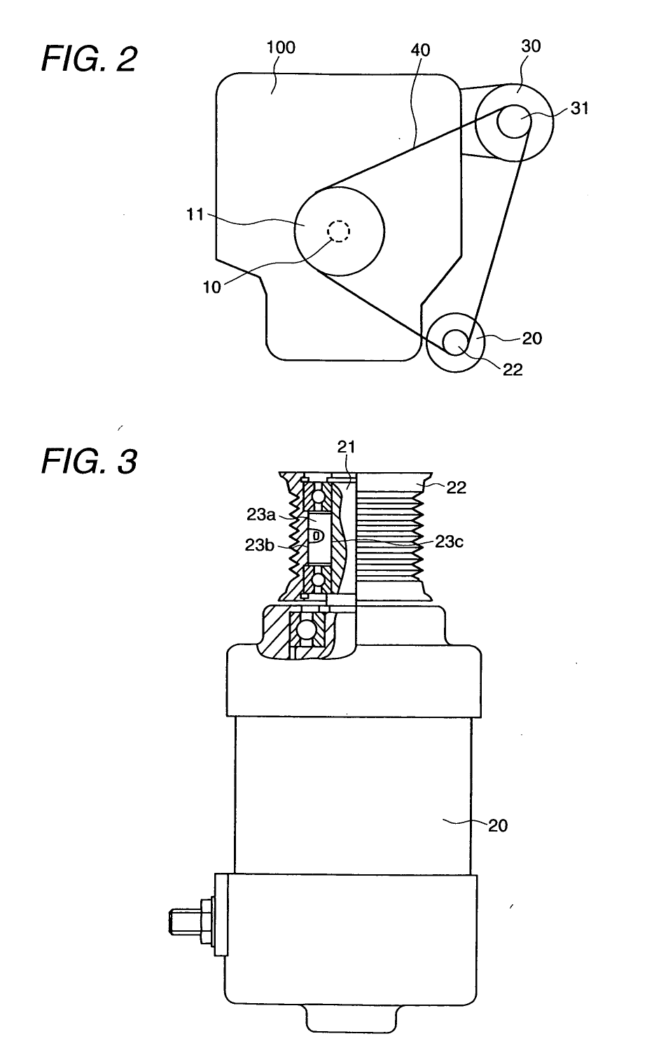

Firstly, an entire configuration of the internal combustion engine starting apparatus in this mode of embodiment is explained using FIG. 2 and FIG. 2.

FIG. 1 is an illustration of the entire configuration of the internal combustion engine starting apparatus in one mode of embodiment of the present invention. FIG. 2 is a side elevation of the apparatus in FIG. 1.

As shown in FIG. 1, the crank pulley 11 in the reduction side is fitted on the crankshaft 10 of the internal combustion engine 100. The other end of the crankshaft 10 has the ring gear 12 being fitted thereon. The motor pulley 22 in the over-drive side is fitted on the output shaft 21 of the direct current motor 20 via the lift off type one-way clutch 23. The lift off type one-way clutch 23 is a clutch that transmits the rotation of the output shaft 21 of the direct current motor 20 in one-way to the motor pulley 22 and opens the connection between the output shaft 21 and the motor pulley 22 causing them to be completely isolated each from the other when the number of revolution of the motor pulley 22 rises beyond specified number of revolution. De tails of the construction of the lift off type one-way clutch 23 will be described later using FIG. 3.

The direct current motor 20 has a reducer built-in, which is not illustrated. The output pulley 31 is fitted on the output shaft of the alternato r 30. As shown in FIG. 1 and FIG. 2, the power transmission belt 40 is arranged over the crank pulley 11 in the reduction side, the motor pulley 22 in the over-drive side, and the output pulley 31. When the internal combustion engine 100 has an engine displacement of 1500 cc, the direct current motor 20 to be used is a motor driven by a 12-volt direct current voltage and having a maximum output 1.2 kW. The reduction ratio across the crank pulley 11 in the reduction side and the motor pulley 22 in the over-drive side is set at 2.5.

The ignition switch 50 has three switching positions: off position (OFF), drive position (D), and start position (ST). When a driver turns the ignition switch 50 into the drive position (D), the engine control unit (ECU) 70 is excited by the battery 90. When the driver further turns the ignition switch 50 into the start position (ST), the relay 60 is excited by the battery 90 closing the contact 61 to allow the battery 90 to flow current to the direct current motor 20, w hich causes the direct current motor 20 to be rotated. When the direct current motor 20 rotates, a reduced power, which is a power speed-reduced by the internal reducer not illustrated, is transmitted through the train formed by, and in this order, the output shaft 21—the lift off type one-way cam clutch 23—the power transmission belt 40—the crank pulley 11—the crankshaft 10 to make the cranking of the internal combustion engine 100. In this transmission, the revolution of the output shaft 21 of the direct current motor 20 is conveyed to the crankshaft 10 with a reduction rate of 1/2.5. When the driver turns the ignition switch 50 back to D (drive) position, the contact 61 opens causing the direct current motor 20 to stop.

On a vehicle stop, the engine control unit 70 outputs an engine stop signal SEST to stop the internal combustion engine 100 when the engine control unit 70 determines that the vehicle stop satisfies idle stop conditions such as the brake being pedaled and the vehicle speed being zero. Stopping the internal combustion engine 100 is achieved by bringing the signal for regulating fuel volume to be fed to the fuel injection valve, which is not illustrated, down to zero followed by stopping the ignition signal to be sent out to the igniting device, which is not illustrated.

After the idle stop, when the status satisfies re-starting conditions such as acceleration pedaling being active, the engine control unit 70 outputs a relay-ON signal SR to the relay driving (R-DRV) circuit 80. Then the relay driving circuit 80 excites the relay 60 causing the contact 61 to close to allow the direct current motor 20 to rotate, of which rotation cranks the internal combustion engine 100. On determination of the internal combustion engine 100 being under a complete explosion state, the ECU 70 outputs a relay-OFF signal SR to the relay driving circuit 80 making the contact 61 open to cause the direct current motor 20 to stop.

Next, composition of the lift off type one-way clutch 23 that is used in the internal combustion engine starting apparatus in this mode of embodiment is explained using FIG. 3.

FIG. 3 is a fragmentary cross-sectional view to show construction of the lift off type one-way clutch 23 to be used in the internal combustion engine starting apparatus in one mode of embodiment of the present invention. Reference signs in the Figure that are same as those in FIG. 1 denote the same parts.

The lift off type one-way cam clutch 23 is comprised of the c am 23a, the outer element 23b, and the inner element 23c. The outer element 23b of the lift off type cam clutch 23 and the motor pulley 22 are integrated. Further, the inner element 23c and the output shaft 21 are integrated.

The cam 23a arranged between the motor pulley 22 and the output shaft 21 lifts off by the centrifugal force. The lift off type one-way clutch 23 then transmits rotational power of the output shaft 21 of the direct current motor 20 to the motor pulley 22 via engagements of the cam 23a with the inner element 23c and the outer element 23b. When the motor pulley 22 rotates, the cam 23a slips preventing the rotational power from being transmitted from the outer element 23b to the inner element 23c. This feature is the one-way clutch. When the number of revolution of the motor pulley 22 rises beyond specified number of revolution the cam 23a lifts off to open the transmission connection between the output shaft 21 and the motor pulley 22 causing them to be completely isolated each from the other.

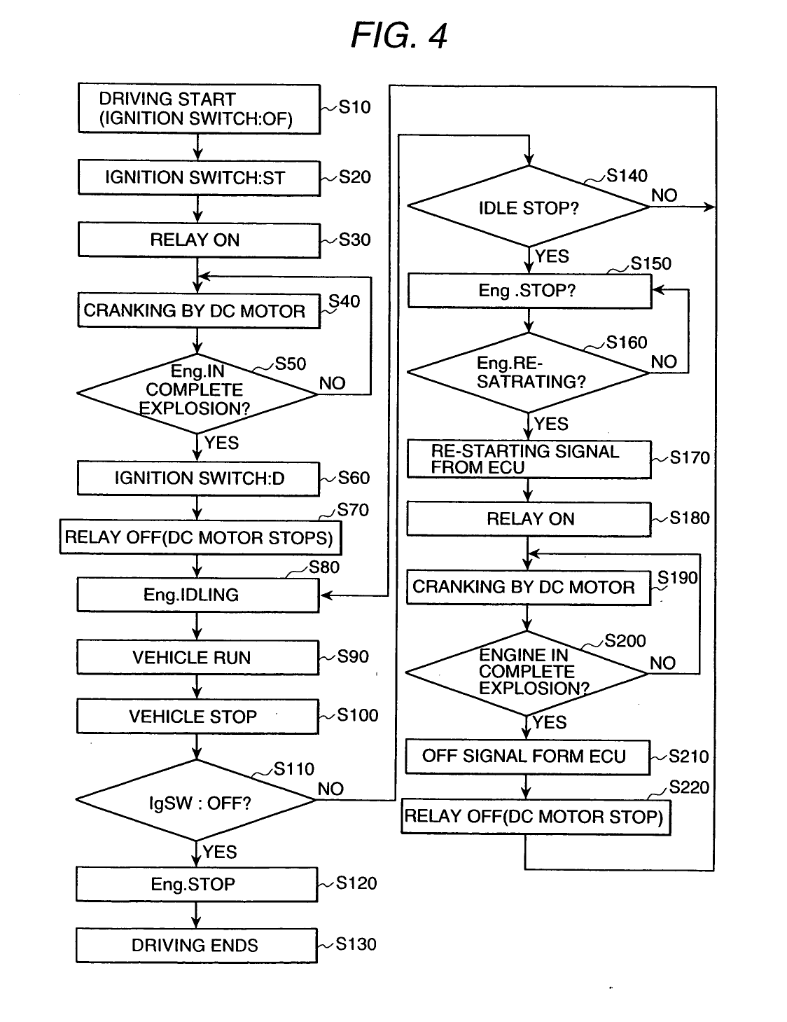

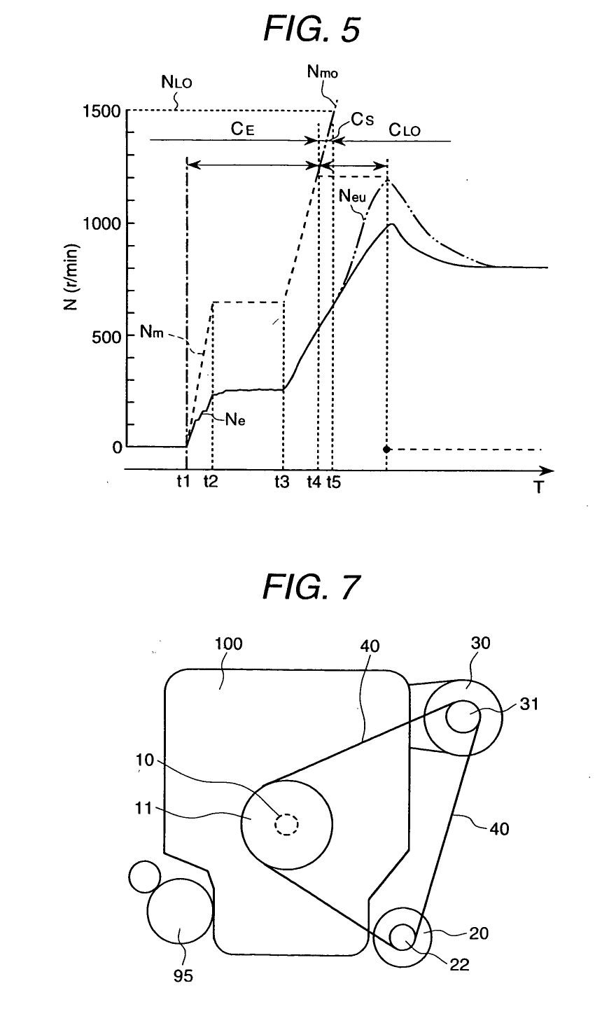

Next, the operation of the internal combustion engine starting apparatus in this mode of embodiment is explained using FIG. 4 and FIG. 5.

FIG. 4 is a flow chart that shows the operation of the internal combustion engine starting apparatus in one mode of embodiment of the present invention. FIG. 5 is an illustration that explains the operation of the lift off type one-way clutch to be used in the internal combustion engine starting apparatus in one mode of embodiment of the present invention. In FIG. 5, the vertical axis denotes number of rotation (r/min) and the horizontal axis time T.

At the time of driving start in the step s10, the ignition switch 50 rests at the off (OFF) position.

Next, in the step s20, the turning of the ignition switch 50 by a driver to ST (start) position causes the contact 61 of the relay 60 to close in the step s30. At the time t0 in FIG. 5, the status of the relay 60 is ON.

Then in the successive step s40, the battery 90 feeds current to the direct current motor 20 and the armature (not illustrated) of the direct current motor 20 rotates. In this step, the cam 23a of the lift off type one-way cam clutch 23 is under engaged state CE. Therefore, a reduced power, which is a power speed-reduced by the internal reducer not illustrated, is transmitted through the train formed by, and in this order, the output shaft 21—the lift off type one-way cam clutch 23—the motor pulley 22—the power transmission belt 40—the crank pulley 11—the crankshaft 10 to make the cranking of the internal combustion engine 100. In FIG. 5, the time period between the times t1 and t2 indicates that the internal combustion engine 100 is in the cranking state. Also in FIG. 5, the solid line Ne shows the number of revolution of the crankshaft 10 of the internal combustion engine 100 and the dotted line Nm shows the number of revolution of the output shaft 21 of the direct current motor 20. Because the reduction ratio across the motor pulley 22 and the crank pulley 11 is set at 1/2.5, Nm is given a speed determined by Nm=2.5×Ne.

In the step s50, the driver judges whether or not the internal combustion engine 100 is in the complete explosion state and turns back the ignition switch 50 to D (drive) position in the step s60 when the engine status is under the complete explosion state. The time t3 in FIG. 5 shows the time when the internal combustion engine reaches the complete explosion state. After the time t3, the combustion engine 100 self-rotates relying on its self-explosion and the number of revolution Ne sharply rises. As the consequence to this, the number of revolution Nm of the direct current motor 20 rises at a rate of 2.5 times the number of revolution Ne of the internal combustion engine 100. When the number of revolution of the direct current motor 20 at the time t4 goes up to its idling speed, the number of revolution Nm of the inner element 23c, which is integrated with the output shaft 21 of the direct current motor 20, does not rise more than that.

After the time t4 however, the number of revolution of the outer element 23b, which is integrated with the motor pulley 22, rises to the number of revolution Nmo (shown in a two-dot chain line in FIG. 5), which is 2.5 times the number of revolution Ne of the internal combustion engine 100, as the revolution of said internal combustion engine 100 rises. Then, the outer element 23b and the inner element 23c idle with the state of the inner element 23c being slipped (touching) on the cam 23a which is in contact with the outer element 23b. This means that, in FIG. 5, the cam 23a of the lift off type one-way cam clutch 23 is under engaged state CE before the time t4 but said cam 23a of said lift off type one-way cam clutch 23 becomes a slipping state CS after the time t4.

When the numbers of revolution of the internal combustion engine 100, the motor pulley 22, the outer element 23b, and the cam 23a Nmo rise to reach a state such that the motor pulley 22 in the over-driving side, the outer element 23b, the cam 23a rotate at a pre-set number of revolution NL0 for lift off at the time t5, the cam 23a lifts off pulled by the centrifugal force. Then, said outer element 23b and said inner element 23c idle with the state of the in ner element 23c being under non-contact state with said cam 23a. Consequently, the cam 23a of the lift off type one-way cam clutch 23 becomes a lifted-off state (CL0), a non-contact state. The number of revolution NL0 for lift off is set between 1000 r/min, which is a revolution 2.5 times a revolution of 400 r/min at which revolution the internal combustion engine 100 can perform the complete explosion, and 1750 r/min, which is a revolution 2.5 times a revolution of 700 r/min at which revolution the internal combustion engine 100 can run idle maintaining self-revolution (so-called idling speed of revolution). In the example shown in FIG. 5, such number of revolution NL0 for lift off is set at 1500 r/min. Thereby, a starting failure is prevented.

When the lift off type one-way cam clutch 23 lifts off at the time t5, the direct current motor 20 becomes not a load to the internal combustion engine 100 resulting in a sudden release of load to the internal combustion engine 100. This invites a sharp rise in the number of revolution (so-called a revving-up) as the alternate long and short dash line Neu in FIG. 5 shows. In this mode of embodiment therefore, the engine control unit 70 sends a revolution-suppressing signal SND to the alternator 30 to control the alternator 30 so that the load to the internal combustion engine 100 is increased to suppress such sharp rise in the number of revolution. To be more specific, the sharp rise in the number of revolution resulted from complete explosion is suppressed after the time t5 as the solid line in FIG. 5 shows by the method of: providing a dummy load in the alternator 30; passing current through the dummy load using an IC regulator provided inside the alternator 30 to falsely increase the load; and thereby el iminating fluctuation of the amount of load before and after the lift off. As another method of eliminating fluctuation of the amount of load, driving a compressor or lighting a headlamp triggering by the revolution-suppressing signal SND after the lift off is a probable method other than providing a dummy load in the alternator 30.

When the driver rests the ignition switch 50 at the drive (D) position in the step s60, the contact 61 opens in the step s70 causing the relay 60 to be OFF then the direct current motor 20 stops. On this stop, both the direct current motor 20 and the inner element 23c make stops but the outer element 23b alone continues rotation (idling) dragged by the internal combustion engine 100.

In the step s80, the internal combustion engine 100 then becomes idling state. The vehicle begins running in the step s90 and stops in the step s100.

On the vehicle stop, the engine control unit 70 judges in the step s110 whether or not the ignition switch 50 is in the off (OFF) state. When the state is the off (OFF) state, the internal combustion engine is stopped in the step s120 and the driving ceases in the step s130.

When the judgment performed in the step s110 tells that the ignition switch 50 is not in the off (OFF) state, another judgment is performed in the step s140 to examine whether idle stop conditions are satisfied or not. As an idle stop condition, a state in which vehicle speed is zero with the brake being pedaled can be one of conditions for example. If the idle stop conditions are not satisfied, the operation returns to the step s80 to continue idling. When idle stop conditions are satisfied, the internal combustion engine 100 is stopped in the step s150.

In the idle stop state, the judgment whether or not the internal combustion engine is to be re-started is performed in the step s160. As a judgment criterion, occurrence of acceleration pedaling for example is used as the criterion to re-start the internal combustion engine. If re-starting condition is not satisfied, the stop state of the internal combustion engine in the step s150 is retained. When re-starting condition is satisfied, the engine control unit 70 outputs a relay ON signal SEST to the relay driving circuit 80 in the step s170. Then the contact 61 closes in the step s180 causing the relay 60 to be brought to ON state and the direct current motor 20 rotates in the step s190. When the direct current motor 20 rotates, a reduced power, which is a power speed-reduced by the internal reducer not illustrate, is transmitted through the train formed by, and in this order, the output shaft 21—the lift off type one-way cam clutch 23—the motor pulley 22—the power transmission belt 40—the crank pulley 11—the crankshaft 10 to make the cranking of the internal combustion engine 100. The time t1 in FIG. 5 is the timing when the relay 60 becomes ON. After the time t1, the cranking of the internal combustion engine 100 begins. Succeeding states are the same states as those in previous descriptions related to FIG. 5.

It is however necessary to increase the output of the direct current motor 20 for cranking the internal combustion engine at its initial starting in the step s40 because an internal combustion engine imposes a heavy load on a cranking when the internal combustion engine is cool. Assuming that required output of the direct current motor 20 for such initial start is 12 V, 1.2 kW, required output of the direct current motor 20 for cranking to re-start the internal combustion engine after idle stop can be reduced to, for example, 0.6 kW because the internal combustion engine has been warmed up. When exciting the direct current motor 20 through activating the relay driving circuit 80 using the engine control unit 70, the power consumption for re-starting can be reduced by reducing the current to be passed through the direct current motor 20.

When the ECU 70 determines that the internal combustion engine 100 is in the complete explosion state in the step s200, the ECU 70 outputs a relay OFF signal SEST to the relay driving circuit 80 in the step s210. Then, the contact 61 opens in the step s220 causing the direct current motor 20 to stop with the ceasing from so-called the re-starting in the idle stop.

Additionally, although above explanation describes that the lift off type one-way cam clutch 23 is arranged between the output shaft 21 of the direct current motor 20 and the motor pulley 22, arranging in any place between the crankshaft 10 of the internal combustion engine 100 and the rotor shaft of the direct current motor 20 is acceptable. For example, arranging the lift off type one-way cam clutch 23 between the crankshaft 10 of the internal combustion engine 100 and the crank pulley 11, or, when the reducer is accommodated inside the direct current motor 20, arranging between the rotor shaft of the direct current motor 20 and the input shaft of the reducer is also practicable. The most suitable location among these places is the place, especially, between the output shaft 21 of the direct current motor 20 and said motor pulley 22 as shown in FIG. 1. In this case, the number of revolution for lift off is set at a value between, as stated previously, 1000 r/min and 1750 r/min, for example at 1500 r/min. In this instance, the number of revolution for lift off might involve an error about plus/minus 100 r/min because of dimensional accuracy of the lift off type one-way cam clutch 23. However, when 1500 plus/minus 100 r/min is assumable as stated above, accommodating within a planned range from 1000 r/min to 1750 r/min becomes practicable; then designing the lift off type one-way cam clutch 23 becomes easy. In contrast to the above, when the lift off type one-way cam clutch 23 is arranged between the crankshaft 10 of the internal combustion engine 100 and the crank pulley 11, the number of revolution for lift off is set at a value between 400 r/min and 700 r/min, for example at 600 r/min, when the reduction ratio across the crank pulley 11 and the motor pulley 22 is assumed to be 2.5. In this setting, when the error in the number of revolution for lift off is assumed to be plus/minus 100 r/min and accordingly 600 plus/minus 100 r/min, it is necessary to improve accuracy of the lift off type one-way cam clutch 23 for accommodating within a planned range from 400 r/min to 700 r/min. When said lift off type one-way cam clutch 23 is arranged between the rotor shaft of the direct current motor 20 and the input shaft of the reducer, the number of revolution for lift off is a product of the inverse number of the reduction ratio of the reducer. Although this feature makes designing a lift off type one-way cam clutch easy, the life time becomes shorter because the motor pulley 22 and the reducer are rotated by dragging by the internal combustion engine once the internal combustion engine begins complete explosion.

According to this mode of embodiment as explained above, the power of the direct current motor 20 is transmitted with the power transmission belt 40 to the internal combustion engine 100 and accordingly noise, which will be emitted when the pinion on the starter motor and the ring gear fitted on the crankshaft engage at the time of starting the internal combustion engine using the starter motor, is eliminated.

Although the internal combustion engine 100, the direct current motor 20, and the lift off type one-way cam clutch 23 are linked fulitime by the power transmission belt 40, the inner element 23c becomes non-contacting state with the cam 23a because the cam 23a is pulled by the centrifugal force when the number of revolution of the lift off type one-way cam clutch 23, which rotates at a number of revolution 2.5 times of the internal combustion engine 100, reaches the preset number of revolution for lift off (1500 r/min for example). Therefore, the lift off type one—way cam clutch 23 and the direct current motor 20 will not break even the internal combustion engine 100 rotates at a high speed. Further to the above, even the internal combustion engine 100 becomes high speed rotating state, abrasion or wear in clutch components such as the cam 23a, the outer element 23b, or the inner element 23c and abrasion or wear of a brush in the direct current motor 20 are suppressed with elongated life time of the apparatus.

Moreover, because of that the combined use of the direct current motor 100, which is an economical item, with existing components (the relay 60, the rely driving circuit 61, the power transmission belt 60, the ECU 70, the al temator 30, the battery 90, and the ignition switch 50) is employed, the internal combustion engine starting apparatus becomes obtainable in a easier and more economical manner compared with the case like a hybrid vehicle which uses an expensive item such as a 42-volt-driven alternating current motor.

Further, even if the sudden decrease of a load after the lift off of the cam 23a occurs, a sharp rise in the number of revolution (so-called a revving-up) attributable to the complete explosion can be suppressed because the load on the internal combustion engine 100 is increased by controlling the alternator 30.

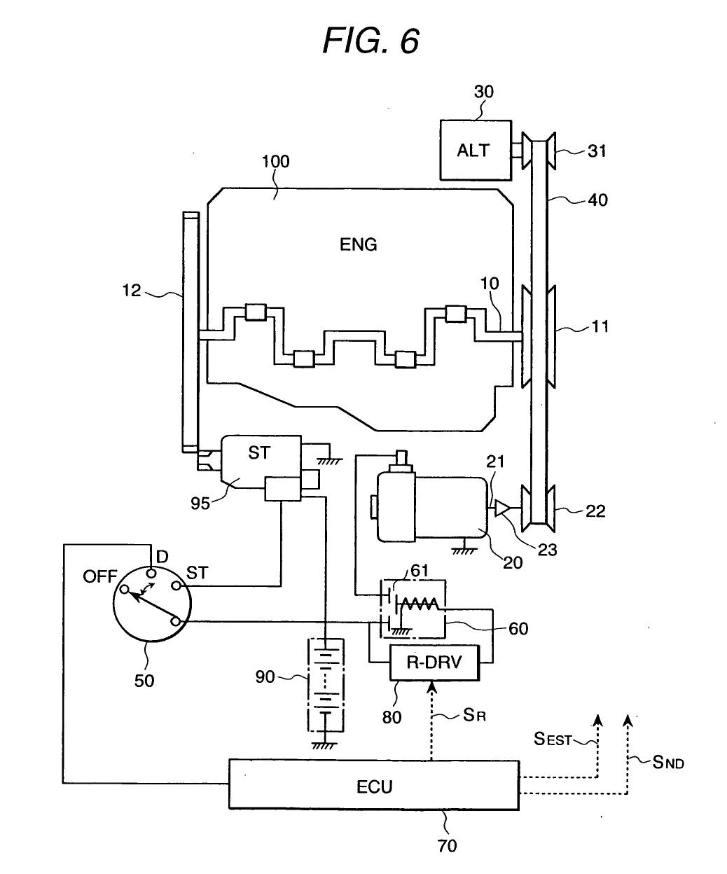

The following explains, using FIG. 6 and FIG. 7, configuration and the operation of an internal combustion engine starting apparatus in another mode of embodiment of the present invention. This mode of embodiment is suitable for a vehicle that uses a large gasoline engine having an engine displacement of 2000 cc or more and a vehicle that uses a diesel engine for example.

FIG. 6 is an illustration of the entire configuration of the internal combustion engine starting apparatus in another mode of embodiment of the present invention.

FIG. 7 is a side elevation of the apparatus in FIG. 6. Reference signs in the Figure that are the same as those in FIG. 1 and FIG. 2 denote the same parts.

This mode of embodiment is characterized in that the configuration thereof has the starter motor 95 therein in addition to the same configuration as shown in FIG. 1. Only when the internal combustion engine is started in the state wherein the ignition switch 50 rests at the start (ST) position, i.e. the state so-called initial starting, the internal combustion engine 100 is started by the power of the existing starter motor 95 being reduced by the ring gear 12 fitted on the crankshaft 10. In contrast to this, when the internal combustion engine is started in the state wherein the ignition switch 50 rests at the drive (D) position, i.e. so-called re-starting after the idle stop, the internal combustion engine 100 is started by the power of the direct current motor 20 being deceleratively transmitted through the train composed of the motor pulley 22—the power transmission belt 40—the crank pulley 11.

Especially in a vehicle that uses a large gasoline engine or a diesel engine, the load for the initial starting is large. Therefore, use of a direct current motor having considerably large capacity is required if initial cranking by the direct current motor 20 is intended. However, the starter motor 95 is such unit that an existing vehicle already has been provided with. Then, uses of the starter motor in the initial starting and of the small size direct current motor in the re-starting in the idle stop state after warming-up can reduce the electrical power consumption. In re-starting a 3000 cc gasoline engine vehicle having the idle stop system for example, a 12-volt-driven motor, which is an economical item, having some 1.2 kW of capacity can be used for the direct current motor 20.

According to this mode of embodiment, noise at the time of re-starting in the idle stop of the internal combustion engine can be eliminated because the power of the direct current motor 20 is transmitted by the power transmission belt 40 to the internal combustion engine 100.

The lift off type one-way cam clutch 23 and the direct current motor 20 will not break even the internal combustion engine 100 rotates at a high speed because the lift off type one-way cam clutch 23 becomes non-contacting state when the number of revolution thereof reaches the preset number of revolution for lift off. Further to the above, even the internal combustion engine 100 becomes high speed rotating state, abrasion or wear in clutch components such as the cam 23a, the outer element 23b, or the inner element 23c and abrasion or wear of the brush in the direct current motor 20 are suppressed with elongated life time of the apparatus.

Moreover, because of that the combined use of the direct current motor 100, which is an economical item, with existing components (the relay 60, the rely driving circuit 61, the power transmission belt 40, the ECU 70, the alternator 30, the battery 90, and the ignition switch 50) is employed, the internal combustion engine starting apparatus becomes obtainable in a easier and more economical manner compared with the case like a hybrid vehicle which uses an expensive item such as a 42-volt-driven alternating current motor.

Further, even if the sudden decrease of a load after the lift off of the cam 23a occurs, a sharp rise in the number of revolution (so-called a revving-up) attributable to the complete explosion can be suppressed because the load on the internal combustion engine 100 is increased by controlling the alternator 30.

Although the present invention has been illustrated and described with respect to exemplary embodiment thereof it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1. An internal combustion engine starting apparatus that starts an internal combustion engine comprising
a motor that drives said internal combustion engine;
a power transmission means that transmits driving power of said motor to the crankshaft of said internal combustion engine, said means being arranged between a first pulley fitted on the output shaft of said motor and a second pulley fitted on the crankshaft of said internal combustion engine; and
a lift off type one-way cam clutch arranged between said motor and said internal combustion engine, wherein a cam is lifted off by the centrifugal force causing release of power transmission engagement between an inner element and an outer element.

2. An internal combustion engine starting apparatus according to claim 1, wherein
said power transmission means is means for power-reducing transmission that reductively transmits power from said first pulley to said second pulley, and
said lift off type one-way cam clutch is arranged between the output shaft of said motor and said first pulley.

3. An internal combustion engine starting apparatus according to claim 2, wherein
said motor is provided with a reducer therein,
said inner element of said lift off type one-way clutch is integrally arranged on the output shaft of said reducer, and
said outer element is integrally arranged on said second pulley.

4. An internal combustion engine starting apparatus according to claim 1, wherein said lift off type one-way cam clutch is set so that said cam lifts off when a number of revolution thereof falls between such speeds wherein one number of revolution at which said inner combustion engine can self-perform complete explosion and the other number of revolution at which said internal combustion engine can run idle maintaining self-revolution.

5. An internal combustion engine starting apparatus according to claim 1, further comprising a control means that increases a load on said internal combustion engine while the cam of said lift off type one-way cam clutch is being lifted off.

6. An internal combustion engine starting apparatus according to claim 1, further comprising
a relay that conveys electrical power supplied from a battery to said motor,
a relay driving circuit that drives said relay, and
an engine control unit that controls the internal combustion engine, wherein,
at the time of initial starting-up, said relay is activated through operating an ignition switch to cause said motor to be driven, and,
at the time of re-starting after idle stop, said engine control unit sends a command to said relay driving circuit so that said relay is activated to cause said motor to be driven.

7. An internal combustion engine starting apparatus according to claim 1, further comprising
a starter motor that drives the crankshaft of said internal combustion engine through engagement with the ring gear fitted on the crankshaft,
a relay that feeds electrical power supplied from a battery to the motor,
a relay driving circuit that drives said relay, and
an engine control unit that controls the internal combustion engine, wherein,
at the time of initial starting-up, said starter motor is driven through operating an ignition switch, and,
at the time of re-starting after idle stop, said engine control unit sends a command to said relay driving circuit so that said relay is activated to cause said motor to be driven.

8. An internal combustion engine starting apparatus that starts an internal combustion engine comprising
a motor that drives said internal combustion engine, and
power transmission means that transmits driving power of said motor to the crankshaft of said internal combustion engine, wherein said power transmission means shuts off transmission of power from said internal combustion engine to said motor when the number of revolution of the crankshaft of said internal combustion engine rises beyond specified number of revolution.

9. An internal combustion engine starting apparatus that starts an internal combustion engine comprising
a motor that drives said internal combustion engine, and
a power transmission means that transmits driving power of said motor to the crankshaft of said internal combustion engine, said means being arranged between a first pulley fitted on the output shaft of said motor and a second pulley fitted on the crankshaft of said internal combustion engine;
a lift off type one-way cam clutch arranged between said motor and said internal combustion engine, wherein a cam is lifted off by the centrifugal force causing release of power transmission engagement between an inner element and an outer element; and
a control means that increases a load on sa id internal combustion engine while the cam of said lift off type one-way cam clutch is being lifted off.
